(19) United States
(12) Patent Application Publication
(10) Pub. No.: US 2025/0173302 A1
(43) Pub. Date: May 29, 2025

(54) VIRTUAL INTERFACE TEST FOR A COMPUTE EXPRESS LINK COMPLIANT MEMORY DEVICE

(71) Applicant: Micron Technology, Inc., Boise, ID (US)

(72) Inventor: Michael R. SPICA, Eagle, ID (US)

(21) Appl. No.: 18/957,370

(22) Filed: Nov. 22, 2024

Related U.S. Application Data
(60) Provisional application No. 63/603,883, filed on Nov. 29, 2023.

(51) Int. Cl. G06F 13/42

(52) U.S. Cl. CPC G06F 13/4221; G06F 2213/0026

(57) ABSTRACT

In some implementations, a control unit component of a compute express link (CXL) compliant memory device may transmit, to a generator component of the CXL compliant memory device, an indication of a type of test being performed for the CXL compliant memory device. The generator component may generate a set of instructions based on the type of test being performed for the CXL compliant memory device. The generator component may inject the set of instructions into a data path of the CXL compliant memory device. The control unit component and/or a comparator component of the CXL compliant memory device may extract a set of data from the data path, wherein the set of data is generated by the data path based on the set of instructions. The control unit component may determine a test result based on the set of data.

### CROSS REFERENCE TO RELATED APPLICATION

This Patent Application claims priority to U.S. Provisional Patent Application No. 63/603,883, filed on Nov. 29, 2023, and entitled “VIRTUAL INTERFACE TEST FOR A COMPUTE EXPRESS LINK COMPLIANT MEMORY DEVICE.” The disclosure of the prior Application is considered part of and is incorporated by reference into this Patent Application.

### TECHNICAL FIELD

The present disclosure generally relates to memory devices, memory device operations, and, for example, to a virtual interface test for a compute express link compliant memory device.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system associated with a virtual interface test (VIT) for a compute express link (CXL) compliant memory device.

FIGS. 2A-2E are diagrams of an example associated with a VIT for a CXL compliant memory device.

FIG. 3 is a flowchart of an example method associated with a VIT for a CXL compliant memory device.

### DETAILED DESCRIPTION

A memory device, such as a compute express link (CXL) compliant memory device (sometimes referred to herein simply as a CXL memory device for ease of discussion), may be periodically tested, such as for a purpose of ensuring that the CXL memory device is performing as expected under a variety of conditions. In some examples, a CXL memory device or a similar device may be tested using an external tester, sometimes referred to as a host tester. A host tester may be a specialized testing instrument that is configured to physically connect to a device under test (DUT), such as via a host interface (e.g., a Peripheral Component Interconnect Express (PCIe) interface). The host tester may be configured to communicate with the DUT using specific protocols and/or signaling standards relevant to the memory device's specifications. In some examples, the host tester may generate various test patterns to assess the performance, functionality, and/or reliability of the DUT. For example, certain test patterns may include read and write operations, addressing different areas of memory, stressing the memory device under various conditions, among other examples. In some examples, a type of test performed by the host tester may be related to timing and/or signal integrity analysis (e.g., an analysis of timing characteristics and signal integrity of the data exchanged between the host tester and the memory device to ensure that data is transmitted accurately and within specified time limits and/or that the memory device meets certain performance requirements), functional testing (e.g., testing various access modes, checking for errors, and/or verifying the device's compliance with industry standards), protocol compliance (e.g., a verification that the memory device is adhering to specific communication protocols and/or standards), and/or power and/or thermal testing (e.g., an assessment of the memory device's power consumption and/or thermal characteristics), among other examples. In some examples, the host tester may be configured to collect and analyze the data obtained from the tests, such as by identifying any errors and/or deviations from an expected behavior of the DUT, and/or the host tester may be configured to provide a report providing detailed information about the memory device's performance.

In some cases, using a host tester to test the performance of a memory device may be costly and/or resource intensive. For example, because a host tester must be physically connected to a DUT (e.g., via a PCIe interface), a host tester may not be feasible in certain installation scenarios in which a PCIe interface of a memory device or similar interface is not readily accessible for testing. This may result in memory devices that are not frequently tested, resulting in unidentified memory faults and thus lost or corrupted host data and poor memory device performance. Moreover, utilizing a host tester may be associated with relatively lengthy setup times and/or may require that a DUT be disconnected from another host device to perform the testing, leading to increased downtime for the DUT and thus unavailability of resources associated with the DUT.

Some implementations described herein enable a virtual interface test (VIT) for a CXL memory device, among other examples. In some implementations, the VIT may be associated with one or more components of the CXL memory device, such as a control unit component, a generator component, a comparator component, or similar components. For example, one or more of the control unit component, the generator component, the comparator component, or similar components may be associated with one or more application-specific integrated circuits (ASICs) associated with the CXL memory device and/or housed by the CXL memory device. In some implementations, the one or more components may be configured to mimic and/or virtualize one or more operations of a host tester that is physically connected to an interface of the CXL interface (e.g., a PCIe interface) without requiring physical connection to the interface. For example, the one or more components may be configured to inject a set of instructions into a data path (e.g., a physical layer data path, which may be associated with an incoming/outgoing data stream processing command requests, such as read/write commands and/or similar commands) of the CXL memory device and extract a set of data from the data path that is generated by the data path based on the set of instructions. Based on the set of data, the one or more components (e.g., the control unit component) may determine a test result. For example, the set of data may be compared (e.g., using a bitwise exclusive or (XOR) operation) to an expected set of data to determine if the CXL memory device is performing as expected. As a result, as compared to testing performed by a host tester, the VIT may result in less DUT downtime and/or an ability to test the DUT even without physical access to a host interface (e.g., a PCIe interface), leading to more reliable and accessible testing mechanisms, increased memory device reliability, decreased host data loss and/or corruption, and thus reduced power, computing, and memory resources otherwise required to fix errors associated with faulty memory devices.

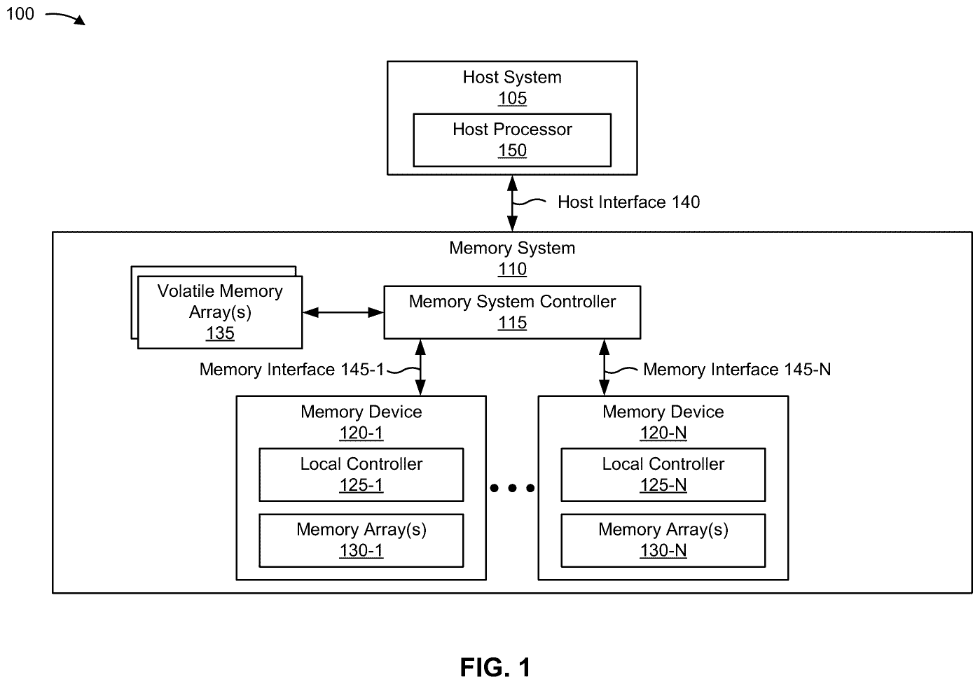

FIG. 1 is a diagram illustrating an example system 100 associated with a VIT for a CXL compliant memory device. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device 120 may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an ASIC, and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a PCIe interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

In some examples, the memory system 110 may be a CXL compliant memory system (sometimes referred to herein simply as a CXL memory system for case of description) and/or one of more of the memory devices 120 may be CXL compliant memory devices. For example, the memory system 110 may include a PCIe/CXL interface (e.g., the host interface 140 may be associated with a PCIe/CXL interface), which may be a physical interface configured to connect the CXL memory system and/or the CXL memory device to CXL compliant host devices. In such examples, the PCIe/CXL interface may comply with CXL standard specifications for physical connectivity, ensuring broad compatibility and case of integration into existing systems using the CXL protocol.

CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide an advanced protocol in areas such as input/output (I/O) protocol, memory protocol, and coherency interface. In some examples, a CXL memory system and/or a CXL memory device may be designed to efficiently interface with computing systems (e.g., the host system 105) by leveraging the CXL protocol. For example, a CXL memory system and/or a CXL memory device may be configured to utilize high-speed, low-latency interconnect capabilities of CXL, such as for a purpose of making the CXL memory system and/or the CXL memory device suitable for high-performance computing, data center applications, artificial intelligence (AI) applications, and/or similar applications.

A CXL memory system and/or a CXL memory device may include a CXL memory controller (e.g., memory system controller 115 and/or local controller 125), which may be configured to manage data flow between memory arrays (e.g., volatile memory arrays 135 and/or memory arrays 130) and a CXL interface (e.g., a PCIe/CXL interface, such as host interface 140). In some examples, the CXL memory controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

A CXL memory system and/or a CXL memory device may further include and/or be associated with one or more high-bandwidth memory modules (HBMMs) or similar memory arrays (e.g., volatile memory arrays 135 and/or memory arrays 130). For example, a CXL memory system and/or a CXL memory device may include multiple layers of DRAM (e.g., stacked and/or interconnected through advanced through-silicon via (TSV) technology) in order to maximize storage density and/or enhance data transfer speeds between memory layers. Additionally, or alternatively, a CXL memory system and/or a CXL memory device may include a power management unit, which may be configured to regulate power consumption associated of the CXL memory system and/or the CXL memory device and/or which may be configured to improve energy efficiency for the CXL memory system and/or the CXL memory device. Additionally, or alternatively, a CXL memory system and/or a CXL memory device may include additional components, such as one or more error correction code (ECC) engines, such as for a purpose of detecting and/or correcting data errors to ensure data integrity and/or improve the overall reliability of the CXL memory system and/or the CXL memory device.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to generate a set of instructions based on a type of test being performed for a CXL compliant memory device; inject the set of instructions into a data path of the CXL compliant memory device; extract a set of data from the data path, wherein the set of data is generated by the data path based on the set of instructions; and determine a test result based on the set of data.

In some implementations, one or more systems, devices, apparatuses, components, and/or controllers of FIG. 1 may be configured to transmit an indication of a type of test being performed for a CXL compliant memory device; generate a set of instructions based on the type of test being performed for the CXL compliant memory device; inject the set of instructions into a data path of the CXL compliant memory device; extract a set of data from the data path, wherein the set of data is generated by the data path based on the set of instructions; and determine a test result based on the set of data.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

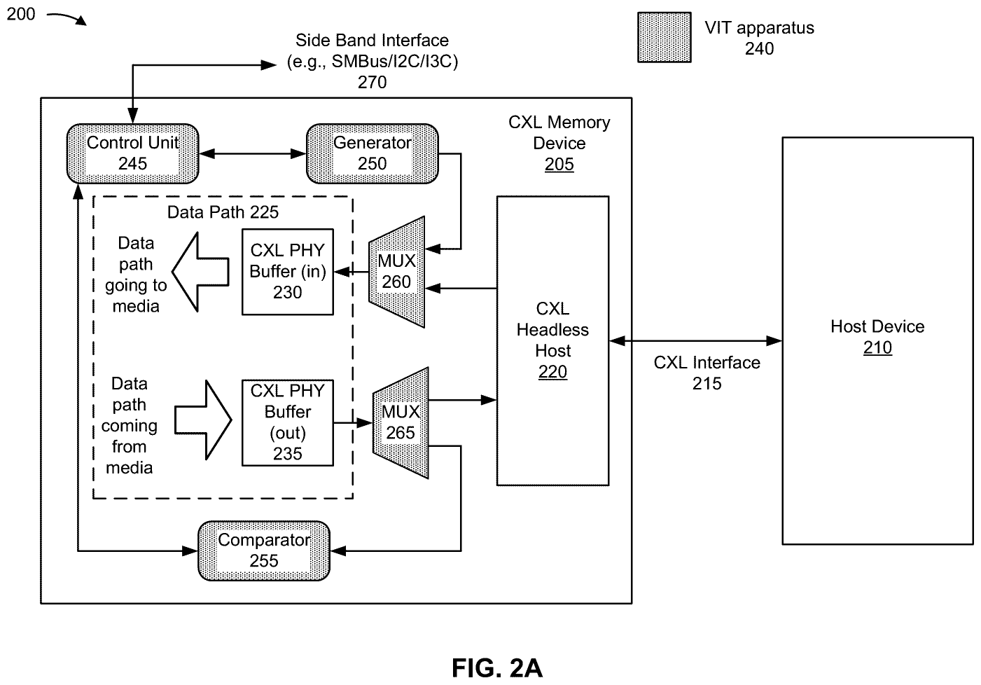

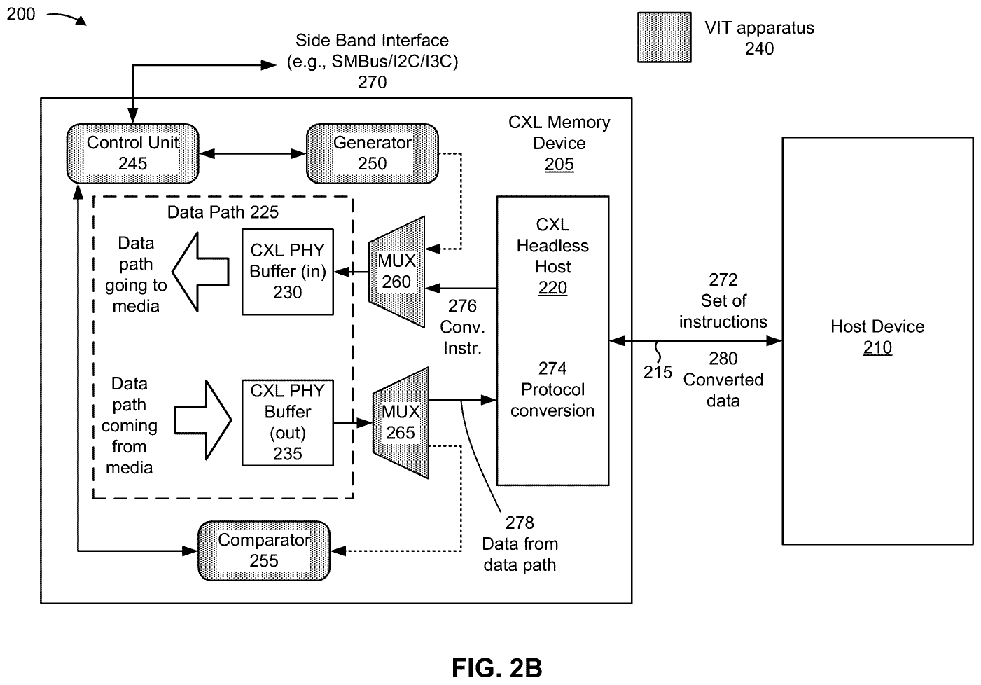

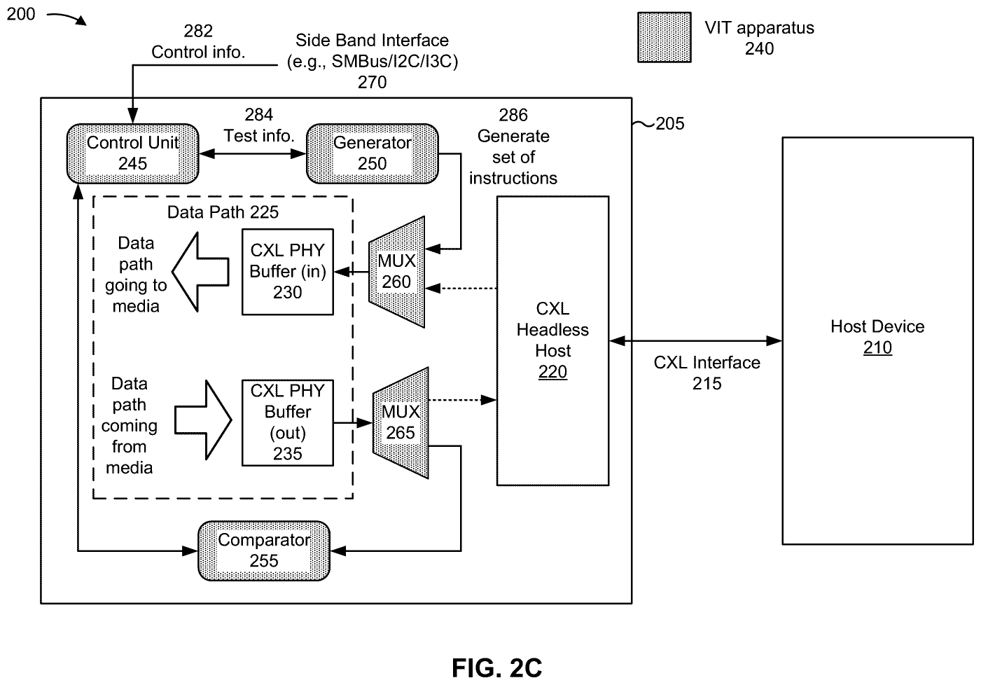

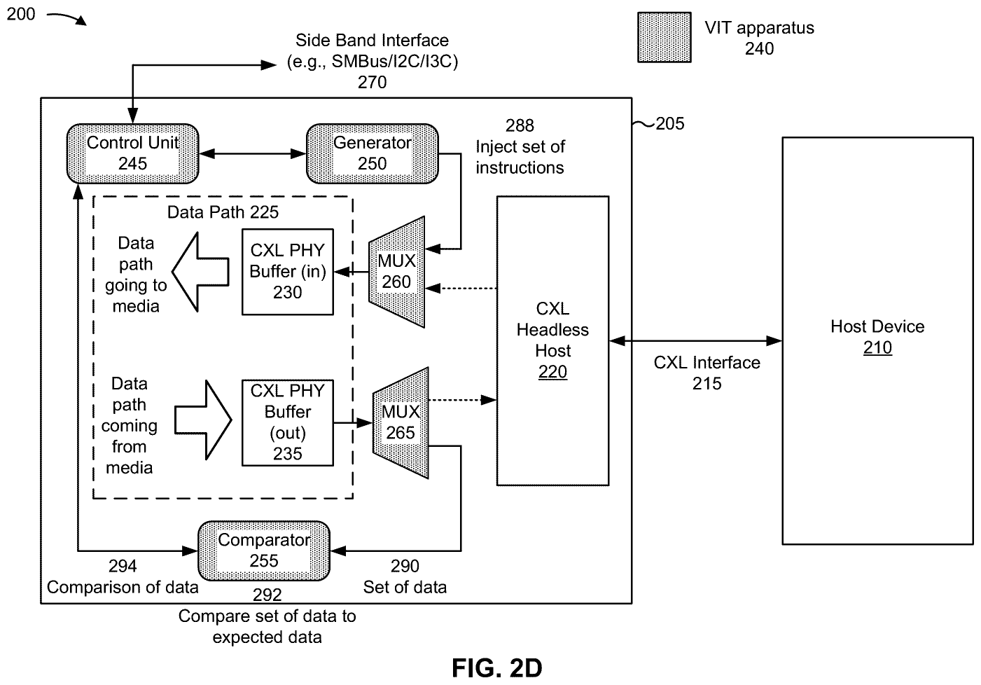

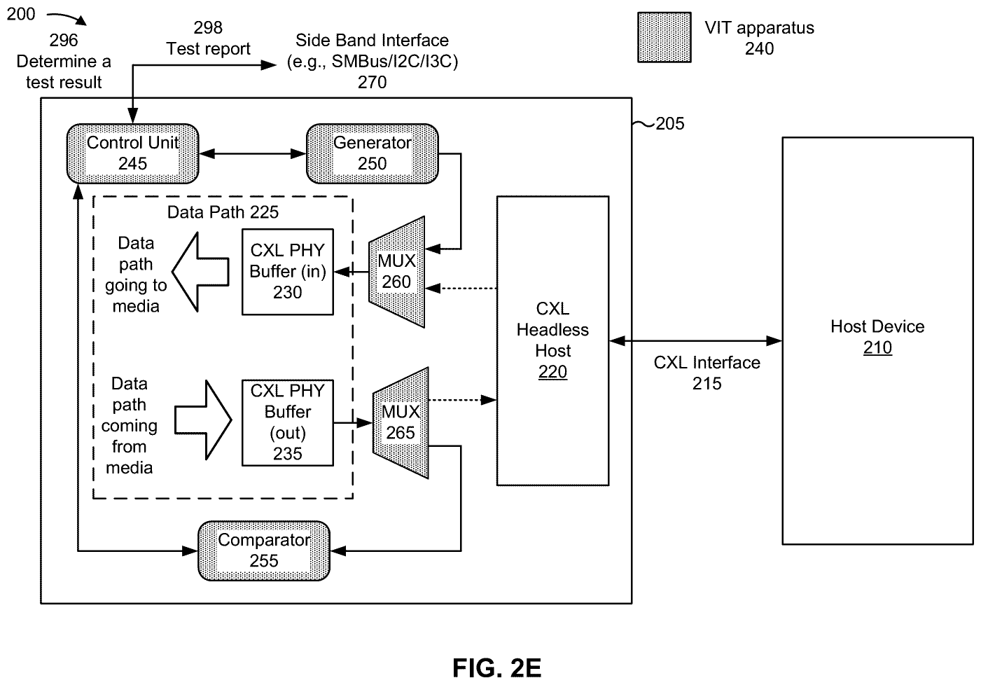

FIGS. 2A-2E are diagrams of an example 200 associated with a VIT for a CXL compliant memory device. The operations described in connection with FIGS. 2A-2E may be performed by the memory system 110 (e.g., a CXL compliant memory system) and/or one or more components of the memory system 110, such as the memory system controller 115, one or more memory devices 120 (e.g., one or more CXL compliant memory devices), and/or one or more local controllers 125. As shown in FIG. 2, the example 200 may include a CXL memory device 205 in communication with a host device 210, such as via a CXL interface 215 (e.g., a PCIe/CXL interface). In some implementations, the CXL memory device 205 may correspond to the memory device 120 and/or the memory system 110, the host device 210 may correspond to the host system 105, and/or the CXL interface 215 may correspond to the host interface 140.

In some implementations, the CXL memory device 205 may include a CXL headless host 220. The CXL headless host 220 may include one or more components that are configured to perform one or more functions associated with communicating with the host device 210 via the CXL interface 215 (e.g., the PCIe/CXL interface), such as by performing protocol conversion functionality (e.g., conversion of a data stream into CXL packets), performing serializer/deserializer (SerDes) functionality (e.g., converting parallel data streams to serial data streams during transmission and/or converting serial data streams to parallel data streams upon reception), performing CXL arbitrator and multiplexer (ARBMUX) functionality (e.g., dynamically multiplexing data coming from multiple protocols and/or routing the multiplexed data to the physical layer), performing analog front end (AFE) functionality (e.g., managing analog aspects of high-speed serial data transmission, such as by conditioning signals, equalizing data, recovering clock information, adapting to channel characteristics, among other examples), and/or performing similar functionality. Moreover, the CXL memory device 205 may include a data path 225 (e.g., a physical layer (PHY) path, an in-band path, a path associated with an incoming/outgoing data stream processing command requests such as read/write commands, or a similar path). The data path 225 may include an incoming data buffer 230 (e.g., a CXL PHY incoming buffer), an outgoing data buffer 235 (e.g., a CXL PHY outgoing buffer), and components configured to route traffic between the incoming data buffer 230 and the outgoing data buffer 235 via a media (e.g., a DRAM, a NAND, or a similar media), such as one or more encoder components, one or more decoder components, one or more buffer manager components, and/or similar components.

In some implementations, the CXL memory device 205 may include a VIT apparatus 240, which may include one or more components that are capable of testing the CXL memory device 205 without physical connection to the CXL interface 215. Put another way, the VIT apparatus 240 may be capable of virtualizing a CXL interface connection, such as for a purpose of mimicking host commands to the CXL memory device 205 when testing a performance of the CXL memory device 205. As shown using stippling in FIG. 2A, in some implementations the VIT apparatus 240 may include a control unit component 245, a generator component 250, a comparator component 255, and one or more multiplexers (MUXs), such as a first multiplexer 260 and a second multiplexer 265.

In some implementations, the control unit component 245 may be capable of controlling operations of the generator component 250 (e.g., to generate a set of instructions based on a type of test to be performed), the comparator component 255 (e.g., to compare data extracted from the data path 225 during a test to expected data), and/or the multiplexers 260, 265 (e.g., by performing lane control associated with the multiplexers 260, 265 to direct traffic from the VIT apparatus 240 to the data path 225 during a test), which is described in more detail below. Additionally, or alternatively, the control unit component 245 may be controllable (e.g., may be configured to receive control information) via a side band interface 270, such as a system management bus (SMBus) interface, an inter-integrated circuit (I2C) interface, an improved inter-integrated circuit (I3C) interface, or a similar side band interface.

In some implementations, the control unit component 245 may be capable of receiving control information (e.g., via a side band interface 270), such as a set of instructions establishing a data type to be used for a test (e.g., one of user-defined data or pseudo-randomly generated data). Additionally, or alternatively, the control unit component 245 may control looping for a given test, such as by causing a set of instructions to be looped through the data path 225 n times during a given test. In implementations in which a test fails, the control unit component 245 may be configured to cause the CXL memory device 205 to halt and/or the control unit component 245 may manage conditions in the case of a halt.

In some implementations, the control unit component 245 may monitor the status of a test operation and/or may be configured to determine a timeout of a test operation. For example, once all run conditions for a given test operation are collected, the control unit component may issue a “start” command to one or more other components of the VIT apparatus 240. Additionally, or alternatively, the control unit component 245 may determine a “running” condition when a test operation is still sequencing. The control unit component 245 may determine a “done” condition when the control unit component 245 determines that a test operation has completed looping, which may cause the comparator component 255 to perform any comparisons (e.g., for test operations in which data comparisons are necessary). Additionally, or alternatively, the control unit component 245 may be configured to determine a “halted” condition, such as in implementations in which an interrupt to the control unit component 245 occurs in the loop.

In some implementations, the control unit component 245 may be configured to manage a debug mode, which may be a variant of the “start” command that permits a single step to increment. In such implementations, the control unit component 245 may manage an increment counter to identify an expected state of the VIT apparatus 240 at a given time. Additionally, or alternatively, the increment counter may be utilized by the generator component 250, such as for a purpose of a pseudo-random generator (e.g., the increment counter may be used by the generator component 250 to determine a cycle of a linear-feedback shift register (LFSR), or the like).

In some implementations, the control unit component 245 may be configured to control a power drive mode of the CXL memory device 205, such as for a purpose of mimicking power consumption of the CXL memory device 205 under normal operating conditions. For example, the control unit component 245 may be configured to mimic the power consumption of the CXL memory device 205 under large load by utilizing a loopback associated with a PCIe physical layer. In some implementations, during a duration of a test operation, the physical layer may be stimulated to collect bit error rate (BER) data as normal, such as by utilizing a pseudo-random binary sequence (PRBS) (e.g., PRBS 31 and/or PRBS 7, among other examples).

In some implementations, the generator component 250 may be capable of creating a buffered set of instructions (e.g., write and/or read instructions) that may be directly injected into a front memory buffer (e.g., the incoming data buffer 230 of the data path 225). Because the front memory buffer is typically reserved for PCIe access and/or device access, injecting the set of instructions directly into the front memory buffer during a test operation may allow maximal insertion into the pipeline to mimic normal operation (e.g., to mimic operation of a connected host device). The generator component 250 may be capable of creating a succession of read operations and/or write operations with fixed data (sometimes referred to as user data), which may be indicated to the generator component 250 by the control unit component 245, and/or by using data generated by a pseudo-random data generator (sometimes referred to as generated data). In the case of generated data, a sequence of the LFSR may be noted in a side buffer for use during comparison on read operations. Addressing within the data packet (e.g., a host physical address (HPA)) may be indicated (e.g., by the control unit component 245) by range and increment, or else may be pseudo-randomly generated by the generator component 250.

The comparator component 255 may be utilized in implementations in which a test operation requires data retrieved from the data path 225 to be compared to an expected set of data. In that regard, the comparator component 255 may be omitted from the VIT apparatus 240 in implementations in which a certain test does not require a comparison of data, such as certain test operations associated with power evaluations and/or activity operations. In some implementations, the comparator component 255 may be capable of performing an XOR operation of the bits of returned data for comparison to expected data (e.g., pseudo-randomly generated data and/or user data). In some implementations, if the XOR of the bits results in a mismatch, the control unit component 245 may cause a halt to the CXL memory device 205. In some implementations, the comparator component 255 may be configured to tap into the host side buffer (e.g., the outgoing data buffer 235) to retrieve data, such as via the second multiplexer 265, which is described in more detail below.

As shown in FIG. 2B, and as indicated by reference number 272, in normal operation (e.g., for read and/or write operations not associated with a VIT), the host device 210 may forward a set of instructions to the CXL memory device 205 via the CXL interface 215, such as a read command or a write command, among other examples. As indicated by reference number 274, the CXL headless host 220 may receive the set of instructions and/or may convert the set of instructions into a form suitable for the physical layer. Moreover, the CXL headless host 220 may inject the converted instructions (shown in FIG. 2B as “conv. instr.”) into a data path 225 associated with the physical layer, as indicated by reference number 276. In some implementations, the data path 225 may include the incoming data buffer 230 (e.g., an incoming CXL PHY buffer), and the outgoing data buffer 235 (e.g., an outgoing CXL PHY buffer), among other components (e.g., components connecting the incoming data buffer 230 and/or the outgoing data buffer 235 to media, such as DRAM or similar media). Moreover, in examples involving the VIT apparatus 240, the CXL memory device 205 may include the first multiplexer 260 between the incoming data buffer 230 and the CXL headless host 220, which may be controllable by the control unit component 245. In such aspects, the CXL headless host 220 may inject the instructions into the data path 225 via the first multiplexer 260 (e.g., the control unit component 245 may perform lane control in the first multiplexer 260 such that, during normal operations, the first multiplexer 260 permits information flow from the CXL headless host 220 to the incoming data buffer 230).

In some implementations, as indicated by reference number 278, data may be exported from the data path 225 (e.g., via the outgoing data buffer 235) based on the set of instructions, such as corresponding host data in cases in which the set of instructions is associated with a read command for host data stored in the media or a write acknowledgement in cases in which the set of instructions is associated with a write command. In examples involving the VIT apparatus 240, the CXL memory device 205 may include the second multiplexer 265 between the outgoing data buffer 235 and the CXL headless host 220, which may be controllable by control unit component 245. In such aspects, the CXL headless host 220 may extract the data via the second multiplexer 265 (e.g., the control unit component 245 may perform lane control in the second multiplexer 265 such that, during normal operations, the second multiplexer 265 permits information flow from the outgoing data buffer 235 to the CXL headless host 220). The CXL headless host 220 may thus extract the data, convert the data to a form suitable for transmission over the CXL interface (as indicated by reference number 274), and/or may transmit the converted data to the host device 210 via the CXL interface 215 (as indicated by reference number 280).

As shown in FIG. 2C, during a VIT operation, the VIT apparatus 240 may be configured to mimic the operation of the host device 210 as described above in connection with FIG. 2B, such that a functionality of the CXL memory device 205 may be evaluated without requiring physical connection to the CXL interface 215 (e.g., without requiring a host tester, or the like). More particularly, as indicated by reference number 282, in some implementations the control unit component 245 may receive, via the side band interface 270, control information indicating that a test is to be performed for the CXL memory device 205. As indicated by reference number 284, based on the control information, the control unit component 245 may determine a type of test (e.g., a type of VIT) to be performed for the CXL memory device 205 and/or may transmit test information to the generator component 250. For example, the control unit component 245 may determine that a read operation test is to be performed (e.g., a test to identify whether the CXL memory device 205 can correctly read data from a given memory address), that a write operation test is to be performed (e.g., a test to identify whether the CXL memory device 205 can correctly write data to a given memory address), that an activity test is to be performed (e.g., a test to identify whether the CXL memory device 205 performs any activity in response to receiving a command), or that a power test is to be performed (e.g., a test to identify whether the CXL memory device 205 is correctly powering on and/or consuming an expected amount of power), among other examples. Accordingly, the control unit component 245 may transmit, and the generator component 250 may receive, an indication of the type of test being performed for the CXL memory device 205. For example, the control unit component 245 may indicate that a read operation test, a write operation test, an activity test, a power test, or another test is to be performed.

Additionally, or alternatively, the control unit component 245 may indicate certain parameters associated with the test. For example, in some implementations, a data set to be used for the test (e.g., a test set of data that is to be written to a portion of memory, among other examples) may be fixed and/or user defined (e.g., via the side band interface 270). In such examples, the control unit component 245 may indicate the user data to the generator component 250. In some other implementations, a data set to be used for the test may be pseudo-randomly generated. In such implementations, the control unit component 245 may indicate to the generator component 250 that the generator component 250 is to pseudo-randomly generate the data set. Similarly, in some implementations, a memory location (e.g., addresses) to be used for the test (e.g., a set of memory addresses where data is to be written to and/or read from) may be fixed and/or user defined (e.g., via the side band interface 270). In such examples, the control unit component 245 may indicate the addresses (e.g., a sequential set of addresses) to the generator component 250. In some other implementations, a memory location to be used for the test may be pseudo-randomly generated. In such implementations, the control unit component 245 may indicate to the generator component 250 that the generator component 250 is to pseudo-randomly generate the memory addresses.

In implementations in which pseudo-randomly generated addressing is utilized, the pseudo-random addressing may be based on a pseudo-random byte sequencer that may utilize a pre-set of correct prime polynomials. In implementations in which sequential addressing is utilized, sequential addressing may include either monotonically increasing or decreasing addressing. In some implementations, the control unit component 245 may initiate a seed address as a starting point, and/or the generator component 250 may be configured to wrap an address range if the sequence goes out of bounds. In some implementations, an initial address indicated to the generator component 250 by the control unit component 245 may be used as a seed address for pseudo-random addressing, or as the offset start point for sequential addressing.

In some implementations, based on information received from the control unit component 245 (e.g., based on the type of test being performed for the CXL memory device 205, the parameters associated with the test, and/or other information), the generator component 250 may generate a set of instructions for the test (sometimes referred to as a combined command), as indicated by reference number 286. The set of instructions (e.g., the combined command) may include an indication of a type of operation to be performed by the CXL memory device 205 (e.g., one of a read command or a write command), a set of data associated with the operation (e.g., a set of data to be written to memory), and/or a location where the operation is to be performed (e.g., a memory address where the read and/or write command is to be performed), among other information.

More particularly, the set of instructions may be associated with a read command for the CXL memory device 205, a write command for the CXL memory device 205, among other examples. Additionally, or alternatively, the set of instructions may include an indication of data associated with a command (e.g., data to be written to a certain location, among other examples), which may be user-defined or pseudo-randomly generated, as described above. Additionally, or alternatively, the set of instructions may include an indication of a memory location associated with a command (e.g., a location where data is to be written to and/or read from, among other examples), which may be a user-defined memory location or a pseudo-randomly generated memory location, as described above. Put another way, the set of instructions may be associated with one or more of a read command to the CXL memory device 205, a write command to the CXL memory device 205, fixed data (e.g., user-defined data) associated with the read command and/or the write command, pseudo-randomly generated data associated with the read command and/or the write command, a set of sequential memory addresses (e.g., user-defined addresses) associated with the read command and/or the write command, and/or a set of pseudo-random generated memory addresses associated with the read command and/or the write command.

As shown in FIG. 2D, and as indicated by reference number 288, the generator component 250 may inject the set of instructions into the data path 225 of the CXL memory device 205. For example, the generator component 250 may inject the set of instructions into the incoming data buffer 230 of the data path 225 via the first multiplexer 260. In that regard, the control unit component 245 may perform lane control in the first multiplexer 260 such that, during VIT operations, the first multiplexer 260 permits information flow from the generator component 250 to the incoming data buffer 230 and restricts normal data flow from the CXL headless host 220 to the incoming data buffer 230 (as shown in FIG. 2D using a broken line for the path between the CXL headless host 220 and the first multiplexer 260). Put another way, the control unit component 245 may engage the first multiplexer 260 to disrupt a normal path to the host device 210, and thus data to fill the pipeline will come from the VIT apparatus 240 components rather than the host device 210.

As indicated by reference number 290, the comparator component 255 (or, in implementations in which a comparison is not performed, the control unit component 245) may extract a set of data from the data path 225. In some implementations, the control unit component 245 may perform lane control with respect to the second multiplexer 265 such that traffic from the data path 225 flows to the comparator component 255 during the test environment. Put another way, the control unit component 245 may engage the second multiplexer 265 to disrupt a normal path to the host device 210, and thus data from the pipeline will flow to the VIT apparatus 240 components rather than to the host device 210. The set of data may be data that is generated by the data path 225 based on the set of instructions. For example, in the case of a VIT involving a read command, the set of data may be data that was read and/or retrieved by the CXL memory device 205 in response to the read command. In the case of a VIT involving a write command, the set of data may be data associated with a write acknowledgement message, or the like.

In some implementations, as indicated by reference number 292, the comparator component 255 may compare the set of data to an expected set of data. For example, the expected set of data may be data known to be written to a given memory location, a known memory location, or similar data. In some implementations, the comparator component 255 may compare the set of data to the expected set of data by using a bitwise XOR operation using bit values of the set of data and bit values of the expected set of data. In some implementations, the comparator component 255 may compare the set of data to the expected set of data based on information provided to the comparator component 255 via the generator component 250 (e.g., via the control unit component 245 and/or a side buffer). For example, the comparator component 255 may calculate an expected address associated with the test operation based on information provided by the generator component, expected data associated with the test operation based on information provided by the generator component, among other information. Accordingly, the comparator component 255 may compare a resultant address (e.g., an address associated with the operation performed by the CXL memory device 205 in response to the set of instructions) to the expected address, and/or the comparator component 255 may compare resultant data (e.g., data associated with the operation performed by the CXL memory device 205 in response to the set of instructions) to the expected data, among other examples. Additionally, or alternatively, the comparator component 255 may transmit, and the control unit component 245 may receive, an indication of a comparison of the set of data to an expected set of data (e.g., the result of the bitwise XOR operation), as indicated by reference number 294.

As indicated by reference number 296, based on the set of data extracted from the data path and/or the comparison of the set of data to an expected set of data, the control unit component 245 may determine a test result. For example, in implementations in which the set of data matches the expected set of data, the control unit component 245 may determine that the CXL memory device 205 passed the test, and thus may cause the CXL memory device 205 to resume normal operation. For example, the control unit component 245 may perform lane control on the first multiplexer 260 and/or the second multiplexer 265 in order to permit normal traffic flow from the host device 210 to the data path 225 while isolating the VIT apparatus 240 from the data path 225. In some other implementations, such as when the set of data does not match the expected set of data, the control unit component 245 may halt operation of the CXL memory device 205. Additionally, or alternatively, as indicated by reference number 298, in some implementations the control unit component 245 may cause a test report to be transmitted to a user, such as via the side band interface 270.

As indicated above, FIGS. 2A-2E are provided as an example. Other examples may differ from what is described with regard to FIGS. 2A-2E.

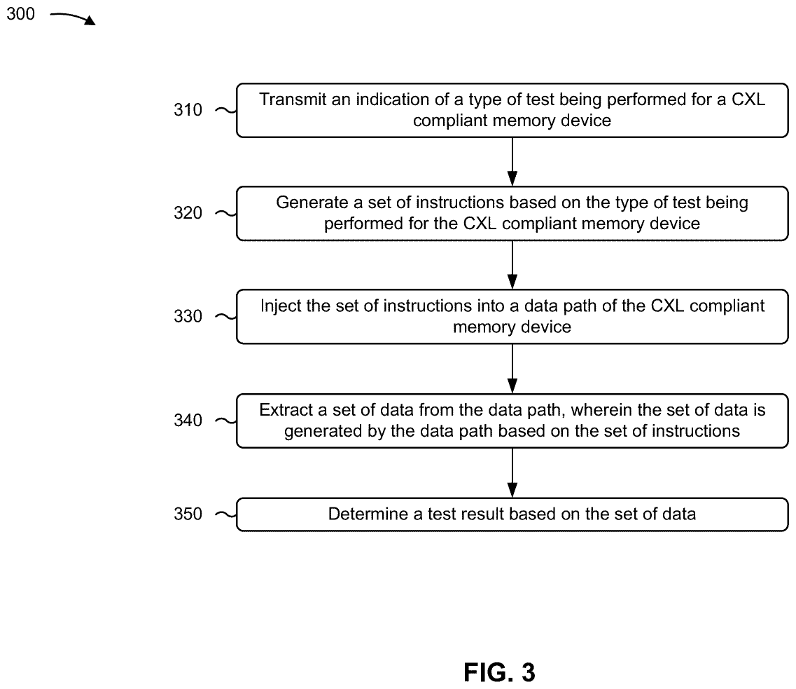

FIG. 3 is a flowchart of an example method 300 associated with a VIT for a CXL compliant memory device. In some implementations, a VIT apparatus (e.g., the VIT apparatus 240) may perform or may be configured to perform the method 300. In some implementations, another device or a group of devices separate from or including the VIT apparatus (e.g., the memory system 110, the memory system controller 115, the memory device 120, and/or the local controller 125) may perform or may be configured to perform the method 300. Additionally, or alternatively, one or more components of the VIT apparatus 240 (e.g., the control unit component 245, the generator component 250, the comparator component 255, and/or the multiplexers 260, 265) may perform or may be configured to perform the method 300. Thus, means for performing the method 300 may include the VIT apparatus 240 and/or one or more components of the VIT apparatus 240. Additionally, or alternatively, a non-transitory computer-readable medium may store one or more instructions that, when executed by the VIT apparatus 240, cause the VIT apparatus 240 to perform the method 300.

As shown in FIG. 3, the method 300 may include transmitting an indication of a type of test being performed for the CXL compliant memory device (block 310). As further shown in FIG. 3, the method 300 may include generating a set of instructions based on the type of test being performed for the CXL compliant memory device (block 320). As further shown in FIG. 3, the method 300 may include injecting the set of instructions into a data path of the CXL compliant memory device (block 330). As further shown in FIG. 3, the method 300 may include extracting a set of data from the data path, wherein the set of data is generated by the data path based on the set of instructions (block 340). As further shown in FIG. 3, the method 300 may include determining a test result based on the set of data (block 350).

The method 300 may include additional aspects, such as any single aspect or any combination of aspects described below and/or described in connection with one or more other methods or operations described elsewhere herein.

In a first aspect, the method 300 includes receiving an indication of a comparison of the set of data to an expected set of data, wherein determining the test result is based on the comparison of the set of data to the expected set of data.

In a second aspect, alone or in combination with the first aspect, the method 300 includes performing a bitwise XOR operation using bit values of the set of data and bit values of the expected set of data, wherein the comparison of the set of data to the expected set of data is based on the bitwise XOR operation.

In a third aspect, alone or in combination with one or more of the first and second aspects, injecting the set of instructions into the data path is performed using a first multiplexer associated with an incoming data buffer of the data path, and extracting the set of data from the data path is performed using a second multiplexer associated with an outgoing data buffer of the data path.

In a fourth aspect, alone or in combination with one or more of the first through third aspects, a control unit component is associated with a side band interface of the CXL compliant memory device.

In a fifth aspect, alone or in combination with one or more of the first through fourth aspects, the set of instructions is associated with at least one of a read command or a write command.

In a sixth aspect, alone or in combination with one or more of the first through fifth aspects, the set of instructions is associated with at least one of fixed data or pseudo-randomly generated data.

In a seventh aspect, alone or in combination with one or more of the first through sixth aspects, the set of instructions is associated with at least one of a set of sequential memory addresses or a set of pseudo-random generated memory addresses.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

In some implementations, a virtual interface test (VIT) apparatus for a compute express link (CXL) compliant memory device includes one or more components configured to: generate a set of instructions based on a type of test being performed for the CXL compliant memory device; inject the set of instructions into a data path of the CXL compliant memory device; extract a set of data from the data path, wherein the set of data is generated by the data path based on the set of instructions; and determine a test result based on the set of data.

In some implementations, a method includes transmitting, by a control unit component of a compute express link (CXL) compliant memory device to a generator component of the CXL compliant memory device, an indication of a type of test being performed for the CXL compliant memory device; generating, by the generator component, a set of instructions based on the type of test being performed for the CXL compliant memory device; injecting, by the generator component, the set of instructions into a data path of the CXL compliant memory device; extracting, by at least one of the control unit component or a comparator component of the CXL compliant memory device, a set of data from the data path, wherein the set of data is generated by the data path based on the set of instructions; and determining, by the control unit component, a test result based on the set of data.

In some implementations, a memory device includes a compute express link (CXL) compliant host interface; a data path associated with the CXL compliant host interface including an incoming data buffer and an outgoing data buffer; and a virtual interface test (VIT) apparatus including a control unit component, a generator component, a comparator component, a first multiplexer between the CXL compliant host interface and the incoming data buffer, and a second multiplexer between the outgoing data buffer and the CXL compliant host interface, wherein the VIT apparatus is configured to: transmit, by the control unit component to the generator component, an indication of a type of test being performed for the memory device, generate, by the generator component, a set of instructions based on the type of test being performed for the memory device; inject, by the generator component and using the first multiplexer, the set of instructions into the incoming data buffer of the data path; extract, by one of the control unit component or the comparator component and using the second multiplexer, a set of data from the outgoing data buffer of the data path, wherein the set of data is generated by the data path based on the set of instructions; and determine, by the control unit component, a test result for the type of test being performed for the memory device based on the set of data.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A virtual interface test (VIT) apparatus for a compute express link (CXL) compliant memory device, comprising:
one or more components configured to:
generate a set of instructions based on a type of test being performed for the CXL compliant memory device;
inject the set of instructions into a data path of the CXL compliant memory device;
extract a set of data from the data path, wherein the set of data is generated by the data path based on the set of instructions; and
determine a test result based on the set of data.

2. The VIT apparatus of claim 1, wherein the one or more components, to determine the test result, are configured to compare the set of data to an expected set of data.

3. The VIT apparatus of claim 2, wherein the one or more components, to compare the set of data to the expected set of data, are configured to perform a bitwise exclusive or (XOR) operation using bit values of the set of data and bit values of the expected set of data.

4. The VIT apparatus of claim 1, wherein the one or more components, to inject the set of instructions into the data path, are configured to use a first multiplexer associated with an incoming data buffer of the data path, and
wherein the one or more components, to extract the set of data from the data path, are configured to use a second multiplexer associated with an outgoing data buffer of the data path.

5. The VIT apparatus of claim 1, wherein the one or more components are further configured to receive control information via a side band interface of the CXL compliant memory device.

6. The VIT apparatus of claim 1, wherein the set of instructions is associated with at least one of a read command or a write command.

7. The VIT apparatus of claim 1, wherein the set of instructions is associated with at least one of fixed data or pseudo-randomly generated data.

8. The VIT apparatus of claim 1, wherein the set of instructions is associated with at least one of a set of sequential memory addresses or a set of pseudo-random generated memory addresses.

9. A method, comprising:
transmitting, by a control unit component of a compute express link (CXL) compliant memory device to a generator component of the CXL compliant memory device, an indication of a type of test being performed for the CXL compliant memory device;
generating, by the generator component, a set of instructions based on the type of test being performed for the CXL compliant memory device;
injecting, by the generator component, the set of instructions into a data path of the CXL compliant memory device;
extracting, by at least one of the control unit component or a comparator component of the CXL compliant memory device, a set of data from the data path, wherein the set of data is generated by the data path based on the set of instructions; and
determining, by the control unit component, a test result based on the set of data.

10. The method of claim 9, further comprising receiving, by the control unit component from the comparator component, an indication of a comparison of the set of data to an expected set of data,
wherein determining the test result is based on the comparison of the set of data to the expected set of data.

11. The method of claim 10, further comprising performing, by the comparator component, a bitwise exclusive or (XOR) operation using bit values of the set of data and bit values of the expected set of data,
wherein the comparison of the set of data to the expected set of data is based on the bitwise XOR operation.

12. The method of claim 9, wherein injecting the set of instructions into the data path is performed using a first multiplexer associated with an incoming data buffer of the data path, and
wherein extracting the set of data from the data path is performed using a second multiplexer associated with an outgoing data buffer of the data path.

13. The method of claim 9, wherein the control unit component is associated with a side band interface of the CXL compliant memory device.

14. The method of claim 9, wherein the set of instructions is associated with at least one of a read command or a write command.

15. The method of claim 9, wherein the set of instructions is associated with at least one of fixed data or pseudo-randomly generated data.

16. The method of claim 9, wherein the set of instructions is associated with at least one of a set of sequential memory addresses or a set of pseudo-random generated memory addresses.

17. A memory device, comprising:
a compute express link (CXL) compliant host interface;
a data path associated with the CXL compliant host interface including an incoming data buffer and an outgoing data buffer; and
a virtual interface test (VIT) apparatus including a control unit component, a generator component, a comparator component, a first multiplexer between the CXL compliant host interface and the incoming data buffer, and a second multiplexer between the outgoing data buffer and the CXL compliant host interface, wherein the VIT apparatus is configured to:
transmit, by the control unit component to the generator component, an indication of a type of test being performed for the memory device,
generate, by the generator component, a set of instructions based on the type of test being performed for the memory device;
inject, by the generator component and using the first multiplexer, the set of instructions into the incoming data buffer of the data path;
extract, by one of the control unit component or the comparator component and using the second multiplexer, a set of data from the outgoing data buffer of the data path, wherein the set of data is generated by the data path based on the set of instructions; and
determine, by the control unit component, a test result for the type of test being performed for the memory device based on the set of data.

18. The memory device of claim 17, wherein the VIT apparatus is configured to determine the test result based on comparing, by the comparator component, the set of data to an expected set of data.

19. The memory device of claim 18, wherein the VIT apparatus is configured to compare the set of data to the expected set of data by performing, by the comparator component, a bitwise exclusive or (XOR) operation using bit values of the set of data and bit values of the expected set of data.

20. The memory device of claim 17, wherein the set of instructions is associated with at least one of:
a read command,
a write command,
fixed data,
pseudo-randomly generated data,
a set of sequential memory addresses, or
a set of pseudo-random generated memory addresses.
